(19) United States
(12) Patent Application Publication
(10) Pub. No.: US 2010/0187976 A1
(43) Pub. Date: Jul. 29, 2010

(54) LED CONVERSION PHOSPHORS IN THE FORM OF CERAMIC DODIES

(76) Inventor: Holger Winkler, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/376,860

(22) PCT Filed: Jul. 5, 2007
(86) PCT No.: PCT/EP07/05949

§ 371 Date: Feb. 9, 2009

(30) Foreign Application Priority Data
Aug. 11, 2006 (DE) 10 2006 037 730.3

(51) Int. Cl. H01J 1/62; C09K 11/59; C09K 11/79

(52) U.S. Cl. 313/504; 252/301.4 R; 252/301.4 F; 264/21

(57) ABSTRACT

The invention relates to a ceramic phosphor element obtainable by mixing at least two starting materials with at least one dopant by wet-chemical methods and subsequent thermal treatment to give phosphor precursors and isostatic pressing. The ceramic phosphor element is used as conversion phosphor in LEDs.

The invention relates to a ceramic phosphor element, to the production thereof by wet-chemical methods, and to the use thereof as LED conversion phosphor.

The most important and promising concept for the emission of white light by means of LEDs consists in that an electroluminescent chip of In(Al)GaN (or in the future also possibly based on ZnO) which emits in the blue or near-UV region is coated with a conversion phosphor, which can be excited by the chip and emits certain wavelengths. This combination of chip and phosphor is surrounded by a cast or injection-moulded casing of epoxides, PMMA or other resins in order to protect the combination against environmental influences, where the casing material should be highly transparent in the visible region and stable and invariable under the given conditions (T up to 200° C. and high radiation density and exposure through chip and phosphor).

The phosphors are nowadays employed as micropowders having a broad, production-induced size distribution and morphology: after the phosphors have been dispersed in a matrix of silicones or resins, they are applied dropwise to the chip or into a reflector cone surrounding the chip or incorporated into the casing material, in which case the coating takes place with the casing material (packaging which also includes the electrical contacting of the chip).

In this way, the phosphor is not distributed on/over the chip in a plannable, reproducible and homogeneous manner. This results in the inhomogeneous emission cones which can be observed in today's LEDs, i.e. the LED emits different light at different angles. This behaviour does not lead reproducibly to differences between the LEDs in a batch, meaning that all LEDs are tested and sorted individually (expensive binning processes).

In addition, a considerable proportion of the light emitted by the chip is scattered at the frequently fissured surface of the mostly high-refractive-index phosphor powders and cannot be converted by the phosphor. If this light is scattered back to the chip, absorption occurs in the chip since the Stokes shift between absorption and emission wavelength is negligibly small in semiconductors.

DE 199 38 053 describes an LED which is surrounded by a silicone casing or ceramic part, where phosphor powder may be embedded in the covering as foreign component.

DE 199 63 805 describes an LED which is surrounded by a silicone casing or ceramic part, where phosphor powder may be embedded in the covering as foreign component.

WO 02/057198 describes the production of transparent ceramics, such as YAG:Nd, which may be doped here with neodymium. Ceramics of this type are employed as solid-state lasers.

DE 103 49 038 describes a luminescence conversion element produced by solid-state diffusion processes based on a polycrystalline ceramic element comprising YAG, which is combined with a solution of a dopant. Due to a temperature treatment, the dopant (activator) diffuses into the ceramic element, during which the phosphor forms. The coating of the ceramic element comprising YAG with a cerium nitrate solution is carried out by complex, repeated dip coating (CSD). The diameter of the crystallites here is 1 to 100 μm, preferably 10 to 50 μm. The disadvantage of a ceramic luminescence conversion element of this type produced by solid-state diffusion processes is that firstly a particle composition which is homogeneous at the atomic level is not possible since, in particular, the doping ions have an irregular distribution, which, in the case of concentration hot spots, results in so-called concentration quenching (see Shionoya, Phosphor Handbook, 1998, CRC Press). The conversion efficiency of the phosphor consequently drops. In addition, so-called mixing & firing processes only enable the preparation of micron-sized powders, which do not have a uniform morphology and have a broad particle size distribution. Large particles have greatly reduced sintering activity compared with smaller sub-μm particles. Ceramic formation is consequently made more difficult and further restricted in the case of an inhomogeneous morphology and/or broad particle size distribution.

If the ceramic luminescence conversion element is not located directly on the LED chip, but instead is a few millimetres away therefrom, imaging optics can no longer be employed. The primary radiation from the LED chip and the secondary radiation from the phosphor thus take place at sites which are far apart from one another. With imaging optics, as necessary, for example, for car headlamps, it is not homogeneous light, but instead two light sources that are imaged.

A further disadvantage of the above-mentioned ceramic luminescence conversion element is the use of an organic adhesive (for example acrylates, styrene, etc.). This is damaged by the high radiation density of the LED chip and the high temperature and, due to greying, results in a reduction in the luminous power of the LED.

The object of the present invention is therefore to develop a ceramic phosphor element which does not have one or more of the above-mentioned disadvantages.

Surprisingly, the present object can be achieved by preparing the phosphor by wet-chemical methods with subsequent isostatic pressing. It can then be applied directly to the surface of the chip in the form of a homogeneous, thin and non-porous plate. There is thus no location-dependent variation of the excitation and emission of the phosphor, meaning that the LED provided therewith emits a homogeneous light cone of constant colour and has high luminous power.

The present invention thus relates to a ceramic phosphor element obtainable by mixing at least two starting materials with at least one dopant by wet-chemical methods and subsequent thermal treatment to give phosphor precursor particles, preferably having an average diameter of 50 nm to 5 μm, and isostatic pressing.

Scattering effects at the surface of the phosphor element according to the invention, which preferably has the form of a plate, are negligible since the direct or approximately direct, equidistant contact of the phosphor element with the LED chip causes a so-called near field interaction. This always occurs within separations smaller than the corresponding light wavelength (blue LED=450-470 nm, UV LED=380-420 nm) and is particularly pronounced if the separations are less than 100 nm and is characterised, inter alia, by the absence of scattering effects (formation of elementary waves impossible since the space length present for this purpose is less than the wavelength).

A further advantage of the phosphor elements according to the invention is that complex dispersal of the phosphors in epoxides, silicones or resins is unnecessary. These dispersions known from the prior art comprise, inter alia, polymerisable substances and, owing to these and other constituents, are not suitable for storage.

With the phosphor elements according to the invention, the LED manufacturer is able to store ready-to-use phosphors in the form of plates; in addition, the application of the phosphor ceramic is compatible with the other process steps in LED manufacture, whereas this is not true in the case of application of conventional phosphor powders. The final process step is therefore associated with high complexity, which results in higher costs in LED manufacture.

However, the phosphor elements according to the invention can also be applied directly on top of a finished blue or UV LED if maximum efficiencies, i.e. lumen efficiencies, of the white LED, are not important. It is consequently possible to influence the light temperature and hue of the light by simple replacement of the phosphor plate. This can be carried out in an extremely simple manner by replacing the chemically identical phosphor substance in the form of plates of different thickness.

The material selected for the ceramic phosphor elements can, in particular, be the following compounds, where, in the following notation, the host compound is shown to the left of the colon and one or more doping elements are shown to the right of the colon. If chemical elements are separated from one another by commas and are in brackets, their use is optional. Depending on the desired luminescence property of the phosphor elements, one or more of the compounds available for selection can be used:

BaAl₂O₄:Eu²⁺, BaAl₂S₄:Eu²⁺, BaB₈O,₃:Eu²⁺, BaF₂, BaFBR:Eu²⁺, BaFCl:Eu²⁺, BaFCl:Eu²⁺, Pb²⁺, BaGa₂S₄:Ce³⁺, BaGa₂S₄:Eu²⁺, Ba₂Li₂Si₂ O₇:Eu²⁺, Ba₂Li₂Si₂ O₇:Sn²⁺, Ba₂Li₂Si₂ O₇:Sn²⁺, Mn²⁺, BaMgAl,₀O₁₇:Ce³⁺, BaMgAl₁₀O₁₇:Eu²⁺, BaMgAl₁₀O₁₇:Eu²⁺, Mn²⁺, Ba₂Mg₃F₁₀:Eu²⁺, BaMg₃F₈:Eu²⁺, Mn²⁺, Ba₂MgSi₂O₇:Eu²⁺, BaMg₂Si₂O₇:Eu²⁺, Ba₅(PO₄)₃Cl:Eu²⁺, Ba₅(PO₄)₃Cl:U, Ba₃(PO₄)₂:Eu²⁺, BaS:Au, K, BaSO₄:Ce³⁺, BaSO₄:Eu²⁺, Ba₂SiO₄:Ce³⁺, Li⁺, Mn²⁺, Ba₅SiO₄Cl₆:Eu²⁺, BaSi₂O₅:Eu²⁺, Ba₂SiO₄:Eu²⁺, BaSi₂O₅:Pb²⁺, BaₓSri₁₋ₓF₂:Eu²⁺, BaSrMgSi₂O₇:Eu²⁺, BaTiP₂O₇, (Ba, Ti)₂P₂O₇:Ti, Ba₃WO₆:U, BaY₂F₈ Er³⁺, Yb⁺, Be₂SiO₄:Mn²⁺, Bi₄Ge₃O₁₂, CaAl₂O₄:Ce³⁺, CaLa₄O₇:Ce³⁺, CaAl₂O₄:Eu²⁺, CaAl₂O₄:Mn²⁺, CaAl₄O₇:Pb²⁺, Mn²⁺, CaAl₂O₄:Tb³⁺, Ca₃Al₂Si₃O₁₂:Ce³⁺, Ca₃Al₂Si₃Oi₂:Ce³⁺, Ca₃Al₂Si₃O,₂:Eu²⁺, Ca₂B₅O₉Br:Eu²⁺, Ca₂B₅O₉Cl:Eu²⁺, Ca₂B₅O₉Cl:Pb²⁺, CaB₂O₄:Mn²⁺, Ca₂B₂O₅:Mn²⁺, CaB₂O₄:Pb²⁺, CaB₂P₂O₉:Eu²⁺, Ca₅B₂SiO₁₀:Eu³⁺, Ca_{0.5}Ba_{0.5}Al₁₂O₁₉:Ce³⁺, Mn²⁺, Ca₂Ba₃(PO4)₃Cl:Eu²⁺, CaBr₂:Eu²⁺ in SiO₂, CaCl₂:Eu²⁺ in SiO₂, CaCl₂:Eu²⁺, Mn²⁺ in SiO₂, CaF₂:Ce³⁺, CaF₂:Ce³⁺, Mn²⁺, CaF₂:Ce³⁺, Tb³⁺, CaF₂:Eu²⁺, CaF₂:Mn²⁺, CaF₂:U, CaGa₂O₄:Mn²⁺, CaGa₄O₇:Mn²⁺, CaGa₂S₄:Ce³⁺, CaGa₂S₄:Eu²⁺, CaGa₂S₄:Mn²⁺, CaGa₂S₄:Pb²⁺, CaGeO₃:Mn²⁺, Cal₂:Eu²⁺ in SiO₂, Cal₂:Eu²⁺, Mn²⁺ in SiO₂, CaLaBO₄:Eu³⁺, CaLaB₃O₇:Ce³⁺, Mn²⁺, Ca₂La₂BO₆₋₅:Pb²⁺, Ca₂MgSi₂O₇, Ca₂MgSi₂O₇:Ce³⁺, CaMgSi₂O₆:Eu²⁺, Ca₃MgSi₂O₈:Eu²⁺, Ca₂MgSi₂O₇:Eu²⁺, CaMgSi₂O₆:Eu²⁺, Mn²⁺, Ca₂MgSi₂O₇:Eu²⁺, Mn²⁺, CaMoO₄, CaMoO₄:Eu³⁺, CaO:Bi³⁺, CaO:Cd²⁺, CaO:Cu⁺, CaO:Eu³⁺, CaO:Eu³⁺, Na⁺, CaO:Mn²⁺, CaO:Pb²⁺, CaO:Sb³⁺, CaO:Sm³⁺, CaO:Tb³⁺, CaO:Tl, CaO.Zn²⁺, Ca₂P₂O₇:Ce³⁺, α-Ca₃(PO₄)₂:Ce³⁺, β-Ca₃(PO₄)₂:Ce³⁺, Ca₅(PO₄)₃Cl:Eu²⁺, Ca₅(PO₄)₃Cl:Mn²⁺, Ca₅(PO₄)₃Cl:Sb³⁺, Ca₅(PO₄)₃Cl:Sn²⁺, β-Ca₃(PO₄)₂:Eu²⁺, Mn²⁺, Ca₅(PO₄)₃F:Mn²⁺, Caₛ(PO₄)₃F:Sb³⁺, Caₛ(PO₄)₃F:Sn²⁺, β-Ca₃(PO₄)₂:Eu²⁺, β-Ca₃(PO₄)₂:Eu²⁺, Ca₂P₂O₇:Eu²⁺, Ca₂P₂O₇:Eu²⁺, Mn²⁺, CaP₂O₆:Mn²⁺, α-Ca₃(PO₄)₂:Pb²⁺, α-Ca₃(PO₄)₂:Sn²⁺, β-Ca₃(PO₄)₂:Sn²⁺, β-Ca₂P₂O₇:Sn, Mn, α-Ca₃(PO₄)₂:Tr, CaS:Bi³⁺, CaS:Bi³⁺, Na, CaS:Ce³⁺, CaS:Eu²⁺, CaS:Cu⁺, Na⁺, CaS:La³⁺, CaS:Mn²⁺, CaSO₄:Bi, CaSO₄:Ce³⁺, CaSO₄:Ce³⁺, Mn²⁺, CaSO₄:Eu²⁺, CaSO₄:Eu²⁺, Mn²⁺, CaSO₄:Pb²⁺, CaS:Pb²⁺, CaS:Pb²⁺, Cl, CaS:Pb²⁺, Mn²⁺, CaS:Pr³⁺, Pb²⁺, Cl, CaS:Sb³⁺, CaS:Sb³⁺, Na, CaS:Sm³⁺, CaS:Sn²⁺, CaS:Sn²⁺, F, CaS:Tb³⁺, CaS:Tb³⁺, Cl, CaS:Y³⁺, CaS:Yb²⁺, CaS:Yb²⁺, Cl, CaSiO₃:Ce³⁺, Ca₃SiO₄Cl₂:Eu²⁺, Ca₃SiO₄Cl₂:Pb²⁺, CaSiO₃:Eu²⁺, CaSiO₃:Mn²⁺, Pb, CaSiO₃:Pb²⁺, CaSiO₃:Pb²⁺, Mn²⁺, CaSiO₃:Ti⁴⁺, CaSr₂(PO₄)₂:Bi³⁺, β-(Ca, Sr)₃(PO₄)₂:Sn²⁺Mn²⁺, CaTi₀₋₉Al₀₋₁O₃:Bi³⁺, CaTiO₃:Eu³⁺, CaTiO₃:Pr³⁺, Ca₅(VO₄)₃Cl, CaWO₄, CaWO₄:Pb²⁺, CaWO₄:W, Ca₃WO₆:U, CaYAlO₄:Eu³⁺, CaYBO₄:Bi³⁺, CaYBO₄:Eu³⁺, CaYB₀₋₈O₃₋₇:Eu³⁺, CaY₂ZrO₆:Eu³⁺, (Ca, Zn, Mg)₃(PO₄)₂:Sn, CeF₃, (Ce, Mg)BaAl₁₁O₁₈:Ce, (Ce,Mg)SrAl₁₁O₁₈:Ce, CeMgAl₁₁O₁₉:Ce:Tb, Cd₂B₆O₁₁:Mn²⁺, CdS:Ag⁺,Cr, CdS:In, CdS:In, CdS:In, Te, CdS:Te, CdWO₄, CsF, CsI, CsI:Na⁺, CsI:Tl, (ErCl₃)_{0.25}(BaCl₂)_{o- 75}, GaN:Zn, Gd₃Ga₅O₁₂:Cr³⁺, Gd₃Ga₅O₁₂:Cr, Ce, GdNbO₄:Bi³⁺, Gd₂O₂S:Eu³⁺, Gd₂O₂Pr³*, Gd₂O₂S:Pr, Ce, F, Gd₂O₂S:Tb³⁺, Gd₂SiO₅:Ce³⁺, KAl₁₁O₁₇:Tl⁺, KGa₁₁D₁₇:Mn²⁺, K₂La₂Ti₃O₁₀:Eu, KMgF₃:Eu²⁺, KMgF₃:Mn²⁺, K₂SIF₆:Mn⁴⁺, LaAl₃B₄O₁₂:Eu³⁺, LaAlB₂O₆:Eu³⁺, LaAlO₃:Eu³⁺, LaAlO₃:Sm³⁺, LaAsO₄:E²⁺, LaBr₃:Ce³⁺, LaBO₃:Eu³⁺, (La, Ce, Tb)PO₄:Ce:Tb, LaCl₃:Ce³⁺, La₂O₃:Bi³⁺, LaOBr:Tb³⁺, LaOBr:Tm³⁺, LaOCl:Bi³⁺, LaOCl:Eu³⁺, LaOF:Eu³⁺, La₂O₃:Eu³⁺, La₂O₃:Pr³⁺, La₂O₂S:Tb³⁺, LaPO₄:Ce³⁺, LaPO₄:Eu³⁺, LaSiO₃Cl:Ce³⁺, LaSiO₃Cl:Ce³⁺, Tb³⁺, LaVO₄:Eu³⁺, La₂W₃O₁₂:Eu³⁺, LiAlF₄:Mn²⁺, LiAl₅O₈:Fe³⁺, LiAlO₂:Fe³⁺, LiAlO₂:Mn²⁺, LiAl₅O₈:Mn²⁺, Li₂CaP₂O₇:Ce³⁺, Mn²⁺, LiCeBa₄Si₄O₁₄:Mn²⁺, LiCeSrBa₃Si₄O₁₄:Mn²⁺, LiInO₂:Eu³⁺, LiInO₂:Sm³⁺, LiLaO₂:Eu³⁺, LuAlO₃:Ce³⁺, (Lu, Gd)₂S10₅:Ce³⁺, Lu₂SiO₅:Ce³⁺, Lu₂Si₂O₇:Ce³⁺, LuTaO₄:Nb^{5═}, Lu₁₋ₓYₓAlO₃:Ce³⁺, MgAl₂O₄:Mn²⁺, MgSrAl₁₀O₁₇:Ce, MgB₂O₄:Mn²⁺, MgBa₂(PO₄)₂:Sn²⁺, MgBa₂(PO₄)₂:U, MgBaP₂O₇:Eu²⁺, MgBaP₂O₇:Eu²⁺, Mn²⁺, MgBa₃Si₂O₈:Eu²⁺, MgBa(SO₄)₂:Eu²⁺, Mg₃Ca₃(PO₄)₄:Eu²⁺, MgCaP₂O₇:Mn²⁺, Mg₂Ca(SO₄)₃:Eu²⁺, Mg₂Ca(SO₄)₃:Eu²⁺, Mn², MgCeAlₙ0₁₉:Tb³⁺, Mg₄(F)GeO₆:Mn²⁺, Mg₄(F)(Ge,Sn)O₆:Mn²⁺, MgF₂:Mn²⁺, MgGa₂O₄:Mn²⁺, Mg₈Ge₂O₁₁F₂:Mn⁴⁺, MgS:Eu²⁺, MgSiO₃:Mn²⁺, Mg₂SiO₄:Mn²⁺, Mg₃SiO₃F₄:Ti⁴⁺, MgSO₄:Eu²⁺, MgSO₄:Pb²⁺, MgSrBa₂Si₂O₇:Eu²⁺, MgSrP₂O₇:Eu²⁺, MgSr₅(PO₄)₄:Sn²⁺, MgSr₃Si₂O₈:Eu²⁺, Mn²⁺, Mg₂Sr(SO₄)₃:Eu²⁺, Mg₂TiO₄:Mn⁴⁺, MgWO₄, MgYBO₄:Eu³⁺, Na₃Ce(PO₄)₂:Tb³⁺, NaI:Tl, Na₁₋₂₃K₀₋₄₂Eu₀₋₁₂TiSi₄O₁₁:Eu³⁺, Na_{1.23}K_{0.42}Eu_{0.12}TiSi₅O₁₃.xH₂O:Eu³⁺, Na_{1.29}K_{0.46}Er_{0.08}TiSi₄O₁₁:Eu³⁺, Na₂Mg₃Al₂Si₂O₁₀:Tb, Na(Mg₂₋ₓMnₓ)LiSi₄O₁₀F₂:Mn, NaYF₄:Er³⁺, Yb³⁺, NaYO₂:Eu³⁺, P46 (70%)+P47 (30%), SrAl₁₂O₁₉:Ce³⁺, Mn²⁺, SrAl₂O₄:Eu²⁺, SrAl₄O₇:Eu³⁺, SrAl₁₂O₁₉:Eu²⁺, SrAl₂S₄:Eu²⁺, Sr₂B₅O₉Cl:Eu²⁺, SrB₄O₇:Eu²⁺(F, Cl, Br), SrB₄O₇:Pb²⁺, SrB₄O₇:Pb²⁺, Mn²⁺, SrB₈O₁₃:Sm²⁺, SrₓBa_{y}Cl_{z}Al₂O_{4-z/2}: Mn²⁺, Ce³⁺, SrBaSiO₄:Eu²⁺, Sr(Cl, Br, I)₂:EU²⁺ in SiO₂, SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Eu²⁺,Sm²⁺, SrF₂:Eu²⁺, SrGa₁₂O₁₉:Mn²⁺, SrGa₂S₄:Ce³⁺, SrGa₂S₄:Eu²⁺, SrGa₂S₄:Pb²⁺, SrIn₂O₄:Pr³⁺, Al³⁺, (Sr, Mg)₃(PO₄)₂:Sn, SrMgSi₂O₆:Eu²⁺, Sr₂MgSi₂O₇:Eu²⁺, Sr₃MgSi₂0₈:Eu²⁺, SrMoO₄:U, SrO.3B₂O₃:Eu²⁺, Cl, β-Sr).3B₂O₃:Pb²⁺, β-SRO.3B₂O₃ :Pb²⁺, Mn²⁺, α-SrO.3B₂O₃:Sm²⁺, Sr₆P₅BO₂₀:Eu, Sr₅(PO₄)₃Cl:Eu²⁺, Sr₅(PO₄)₃Cl:Eu²⁺, Pr³⁺, Sr₅(PO₄)₃Cl:Mn²⁺, Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺, Sr₅(PO₄)₃F:Sb³⁺, Sr₅(PO₄)₃F:Sb³⁺, Mn²⁺, Sr₅(PO₄)₃F:Sn²⁺, Sr₂P₂O₇:Sn²⁺, β-Sr₃(PO₄)₂:Sn²⁺, β-Sr₃(PO₄)₂:Sn²⁺, Mn²⁺(Al), SrS:Ce³⁺, SrS:Eu²⁺, SrS:Mn²⁺, SrS:Cu⁺, Na, SrSO₄:Bi, SrSO₄:Ce³⁺, SrSO₄:Eu²⁺, SrSO₄:Eu²⁺, Mn²⁺, Sr₅Si₄O₁₀Cl₆:Eu²⁺, Sr₂SiO₄:Eu²⁺, SrTiO₃:Pr³⁺, SrTiO₃:Pr³⁺, Al³⁺, Sr₃WO₆:U, SrY₂O₃:Eu³⁺, ThO₂:Eu³⁺, ThO₂:Pr³⁺, ThO₂:Tb³⁺, YAl₃B₄O₁₂:Bi³⁺, YAl₃B₄O₁₂:Ce³⁺, YAl₃B₄O₁₂:Ce³⁺, Mn, YAl₃B₄O₁₂:Ce³⁺,Tb³⁺, YAl₃B₄O₁₂:Eu³⁺, YAl₃B₄O₁₂:Eu³⁺, Cr³⁺, YAl₃B₄O₁₂:Th⁴⁺, Ce³⁺, Mn²⁺, YAl0₃:Ce³⁺, Y₃Al₅O₁₂:Ce³⁺, (Y, Gd, Lu, Tb)₃(Al, Ga)₅O₁₂:(Ce, Pr, Sm), Y₃Al₅O₁₂:Cr³⁺, YAIO₃:Eu³⁺, Y₃Al₅O₁₂:Eu^{3r}, Y₄Al₂O₉:Eu³⁺, Y₃Al₅O₁₂:Mn⁴⁺, YAIO₃:Sm³⁺, YAIO₃:Tb³⁺, Y₃Al₅O₁₂:Tb³⁺, YAsO₄:Eu³⁺, YBO₃:Ce³⁺, YBO₃:Eu³⁺, YF₃:Er³⁺, Yb³⁺, YF₃:Mn²⁺, YF₃:Mn²⁺,Th⁴⁺, YF₃:Tm³⁺, Yb³⁺, (Y,Gd)BO₃:Eu, (Y,Gd)BO₃:Tb, (Y,Gd)₂O₃:Eu³⁺, Y_{1.34}Gd_{0.60}O₃(Eu, Pr), Y₂O₃:Bi³⁺, YOBrEu^{3÷}, Y₂O₃:Ce, Y₂O₃:Er³⁺, Y₂O₃:Eu³⁺(YOE), Y₂O₃:Ce³⁺, Tb³⁺, YOCl:Ce³⁺, YOCl:Eu³⁺, YOF:Eu³⁺, YOF:Tb³⁺, Y₂O₃:Ho³⁺, Y₂O₂S:Eu³⁺, Y₂O₂S:Pr³⁺, Y₂O₂S:Tb³⁺, Y₂O₃:Tb³⁺, YPO₄:Ce³⁺, YPO₄:Ce³⁺,Tb³⁺, YPO₄:Eu³⁺, YPO₄:Mn²⁺, Th⁴⁺, YPO₄:V⁵⁺, Y(P, V)O₄:Eu, Y₂SiO₅:Ce³⁺, YTaO₄, YTaO₄:Nb⁵⁺, YVO₄:Dy³⁺, YVO₄:Eu³⁺, ZnAl₂O₄:Mn²⁺, ZnB₂O₄:Mn²⁺, ZnBa₂S₃:Mn²⁺, (Zn, Be)₂SiO₄:Mn²⁺, Zn_{0.4}Cd_{0.6}S:Ag, Zn_{0.6}Cd_{0.4}S:Ag, (Zn, Cd)S:Ag, Cl, (Zn, Cd)S:Cu, ZnF₂:Mn²⁺, ZnGa₂O₄, ZnGa₂O₄:Mn²⁺, ZnGa₂S₄:Mn²⁺, Za₂GeO₄:Mn^{2÷}, (Zn, Mg)F₂:Mn²⁺, ZnMg₂(PO₄)₂:Mn²⁺, (Zn, Mg)₃(PO₄)₂:Mn²⁺, ZnO:Al³⁺, Ga^{3÷}, ZnO:Bi³⁺, ZnO:Ga³⁺, ZnO:Ga, ZnO—CdO:Ga, ZnO:S, ZnO:Se, ZnO:Zn, ZnS:Ag⁺, Cl⁻, ZnS:Ag, Cu, Cl, ZnS:Ag, Ni, ZnS:Au, In, ZnS—CdS (25-75), ZnS—CdS (50-50), ZnS—CdS (75-25), ZnS—CdS:Ag, Br, Ni, ZnS—CdS:Ag⁺, Cl, ZnS—CdS:Cu, Br, ZnS—CdS:Cu, I, ZnS:Cl⁻, ZnS:Eu²⁺, ZnS:Cu, ZnS:Cu⁺, Al³⁺, ZnS:Cu⁺, Cl⁻, ZnS:Cu, Sn, ZnS:Eu²⁺, ZnS:Mn²⁺, ZaS:Mn, Cu, ZnS:Mn²⁺, Te²⁺, ZnS:P, ZnS:P³⁻, Cl⁻, ZnS:Pb²⁺, ZnS:Pb²⁺,Cl⁻, ZnS:Pb, Cu, Zn₃(PO₄)₂:Mn²⁺, Zn₂SiO₄:Mn²⁺, Zn₂SiO₄:Mn²⁺, As⁵⁺, Zn₂SiO₄:Mn, Sb₂O₂, Zn₂SiO₄:Mn²⁺, P, Zn₂SiO₄:Ti⁴⁺, ZnS:Sn²⁺, ZnS:Sn, Ag, ZnS:Sn²⁺, Li⁺, ZnS:Te, Mn, ZnS—ZnTe:Mn²⁺, ZnSe:Cu⁺, Cl, ZnWO₄

The ceramic phosphor element preferably consists of at least one of the following phosphor materials:

(Y, Gd, Lu, Sc, Sm, Tb)₃ (Al, Ga)₅O₁₂:Ce, (Ca, Sr, Ba)₂SiO₄:Eu, YSiO₂N:Ce, Y₂Si₃O₃N₄:Ce, Gd₂Si₃O₃N₄:Ce, (Y, Gd, Tb, Lu)₃Al₅₋ₓSiₓO₁₂₋ₓNₓ:Ce, BaMgAl₁₀O₁₇:Eu, SrAl₂O₄:Eu, Sr₄Al₁₄O₂₅:Eu, (Ca, Sr, Ba)Si₂N₂O₂:Eu, SrSiAl₂O₃N₂:Eu, (Ca, Sr, Ba)₂Si₅N₈:Eu, CaAlSiN₃:Eu, molybdates, tungstates, vanadates, group III nitrides, oxides, in each case individually or mixtures thereof with one or more activator ions, such as Ce, Eu, Mn, Cr and/or Bi.

The ceramic phosphor element can be produced on a large industrial scale, for example, as plates in thicknesses of a few 100 nm to about 500 μm. The plate dimensions (length x width) are dependent on the arrangement. In the case of direct application to the chip, the size of the plate should be selected in accordance with the chip dimensions (from about 100 μm*100 μm to several mm²) with a certain oversize of about 10% to 30% of the chip surface in the case of a suitable chip arrangement (for example flip chip arrangement) or correspondingly. If the phosphor plate is installed above a finished LED, the emitted light cone will be picked up in its entirety by the plate.

The side surfaces of the ceramic phosphor element can be metallised with a light or noble metal, preferably aluminium or silver. The metallisation has the effect that light does not exit laterally from the phosphor element. Light exiting laterally can reduce the light flux to be coupled out of the LED. The metallisation of the ceramic phosphor element is carried out in a process step after the isostatic pressing to give rods or plates, it being possible, if desired, for the metallisation to be preceded by cutting of the rods or plates to the requisite size. To this end, the side surfaces are wetted, for example, with a solution of silver nitrate and glucose and subsequently exposed to an ammonia atmosphere at elevated temperature. During this operation, a silver coating, for example, forms on the side surfaces.

Alternatively, currentless metallisation processes can also be used, see, for example, Hollemann-Wiberg, Lehrbuch der Anorganischen Chemie [Textbook of Inorganic Chemistry], Walter de Gruyter Verlag, or Ullmanns Enzyklopädie der chemischen Technologie [Ullmann's Encyclopaedia of Chemical Technology].

In order to increase the coupling of the electroluminescent blue or UV light from the LED chip into the ceramic, the side facing the chip must have the smallest possible surface area. The ceramic phosphor has a crucial advantage over phosphor particles here: particles have a large surface area and scatter back a large proportion of the light incident on them. This light is absorbed by the LED chip and the constituents present. The achievable light emission from the LED thus drops. The ceramic phosphor element may, in particular in the case of a flip chip arrangement, be applied directly to the chip or substrate. If the ceramic phosphor element is less than or not much more than one light wavelength away from the light source, near field phenomena may have an effect: the energy input by the light source into the ceramic can be increased by a process similar to the FOrster transfer process. Furthermore, the surface of the phosphor element according to the invention that is facing the LED chip can be provided with a coating which has a reflection-reducing action in relation to the primary radiation emitted by the LED chip. This likewise results in a reduction in back-scattering of the primary radiation, enabling the latter to be coupled into the phosphor element according to the invention better. Suitable for this purpose are, for example, refractive index-adapted coatings, which must have a following thickness d: d=[wavelength of the primary radiation from the LED chip/(4* refractive index of the phosphor ceramic)], see, for example, Gerthsen, Physik [Physics], Springer Verlag, 18th Edition, 1995. This coating may also consist of photonic crystals.

The phosphor element according to the invention may, if necessary, be fixed to the substrate of an LED chip by means of a water-glass solution.

In a further preferred embodirhent, the ceramic phosphor element has a structured (for example pyramidal) surface on the side opposite an LED chip (see FIG. 2). This enables the largest possible amount of light to be coupled out of the phosphor element. Otherwise, light which hits the ceramic/environment interface at a certain angle, the critical angle, experiences total reflection, resulting in undesired transmission of the light within the phosphor elements.

The structured surface on the phosphor element is produced by the compression mould having a structured press platen during the isostatic pressing and consequently embossing a structure into the surface. Structured surfaces are desired if the aim is to produce the thinnest possible phosphor elements or plates. The pressing conditions are known to the person skilled in the art (see J. Kriegsmann, Technische keramische Werkstoffe [Industrial Ceramic Materials], Chap. 4, Deutscher Wirtschaftsdienst, 1998). It is important that the pressing temperatures used are ⅔ to ⅚ of the melting point of the substance to be pressed.

Depending on the compression mould, thin plates or rods are obtained as ceramics. Rods then have to be sawn into thin discs in a further step (see FIG. 1).

In a further preferred embodiment, the ceramic phosphor element according to the invention has, on the side opposite an LED chip, a rough surface (see FIG. 2) which carries nanoparticles of SiO₂, TiO₂, Al₂O₃, ZnO₂, ZrO₂ and/or Y₂O₃ or combinations of these materials. A rough surface here has a roughness of up to a few 100 nm. The coated surface has the advantage that total reflection can be reduced or prevented and the light can be coupled out of the phosphor element according to the invention better.

In a further preferred embodiment, the phosphor element according to the invention has, on the surface facing away from the chip, a refractive index-adapted layer which simplifies the coupling-out of the primary radiation and/or the radiation emitted by the phosphor element.

In a further preferred embodiment, the ceramic phosphor element has a polished surface in accordance with DIN EN ISO 4287 (roughness profile test; polished surfaces have roughness class N3-N1) on the side facing the LED chip. This has the advantage that the surface area is reduced, causing less light to be scattered back.

In addition, this polished surface can also be provided with a coating which is transparent to the primary radiation, but reflects the secondary radiation. The secondary radiation can then only be emitted upwards.

The starting materials for the production of the ceramic phosphor element consist of the base material (for example salt solutions of yttrium, aluminium, gadolinium) and at least one dopant (for example cerium). Suitable starting materials are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in inorganic and/or organic liquids. Preference is given to the use of mixed nitrate solutions which contain the corresponding elements in the requisite stoichiometric ratio.

The present invention furthermore relates to a process for the production of a ceramic phosphor element having the following process steps:
a) preparation of a phosphor by mixing at least two starting materials and at least one dopant by wet-chemical methods and subsequent thermal treatment of the resultant phosphor precursors
b) isostatic pressing of the phosphor precursors to give a ceramic phosphor element.

The wet-chemical preparation generally has the advantage that the resultant materials have higher uniformity in relation to the stoichiometric composition, the particle size and the morphology of the particles from which the ceramic phosphor element according to the invention is produced.

For wet-chemical pretreatment of an aqueous precursor of the phosphors (phosphor precursors) consisting, for example, of a mixture of yttrium nitrate, aluminium nitrate, cerium nitrate and gadolinium nitrate solution, the following known methods are preferred:
co-precipitation using an NH₄HCO₃ solution (see P. Palermo et aL, Journ. of the Europ. Cer. Soc., Vol. 25, Issue 9, pp. 1565-1573)
Pecchini process using a solution of citric acid and ethylene glycol (see e.g. A. Rosario et al., J. Sol-Gel Sci. Techn. (2006) 38:233-240)
Combustion process using urea (see P. Ravindranathan et al., J. of Mat. Sci. Letters, Vol. 12, No. 6 (1993) 363-371)
Spray drying of aqueous or organic salt solutions (starting materials)
Spray pyrolysis of aqueous or organic salt solutions (starting materials).

In the case of the above-mentioned co-precipitation, an NH₄HCO₃ solution is added, for example, to the above-mentioned nitrate solutions of the corresponding phosphor starting materials, resulting in the formation of the phosphor precursor.

In the Pecchini process, a precipitation reagent consisting of citric acid and ethylene glycol is added, for example, to the above-mentioned nitrate solutions of the corresponding phosphor starting materials at room temperature, and the mixture is subsequently heated. The increase in viscosity results in the formation of the phosphor precursor.

In the known combustion process, for example, the above-mentioned nitrate solutions of the corresponding phosphor starting materials are dissolved in water, the solution is then refluxed, and urea is added, resulting in the slow formation of the phosphor precursor.

Spray pyrolysis is one of the aerosol processes, which are characterised by spraying of solutions, suspensions or dispersions into a reaction space (reactor) heated in various ways and the formation and deposition of solid particles. In contrast to spray drying at hot-gas temperatures <200° C., spray pyrolysis, as a high-temperature process, involves thermal decomposition of the starting materials used (for example salts) and the re-formation of substances (for example oxides, mixed oxides) in addition to evaporation of the solvent.

The 5 process variants mentioned above are described in detail in DE 102006027133.5 (Merck), which is incorporated in its full scope into the context of the present application by way of reference.

The phosphor precursors prepared by the above-mentioned methods (for example amorphous or partially crystalline or crystalline YAG doped with cerium) consist of sub-μm particles since they consequently have a very high surface energy and have very high sintering activity. The median of the particle size distribution [Q(x=50%)] of the ceramic phosphor element according to the invention is in the range from [Q(x=50%)]=50 nm to [Q(x=50%)]=5 μm, preferably from [Q(x=50%)]=80 to [Q(x=50%)]=1 μm. The particle sizes were determined on the basis of SEM photomicrographs by determining the particle diameters manually from the digitalised SEM images.

The phosphor precursors are subsequently subjected to isostatic pressing (at pressures between 1000 and 10,000 bar, preferably 2000 bar, in an inert, reducing or oxidising atmosphere or in vacua) to give the corresponding plate form. The phosphor precursors are preferably also mixed with 0.1 to 1% by weight of a sintering aid, such as silicon dioxide or magnesium oxide nanopowder, before the isostatic pressing. An additional thermal treatment can subsequently be carried out by treating the compact at ⅔ to ¾ of its melting point in a chamber furnace, if desired in a reducing or oxidising reaction-gas atmosphere (O₂, CO, H₂, H₂/N₂, etc.), in air or in vacuo.

In particular in order to achieve a homogeneous structure and pore-free surface of the phosphor plate, it may be necessary to convert the powder particles into the phosphor plate by hot isostatic pressing instead of isostatic pressing. In this case, a homogeneous, pore-free material composite which is isotropic to a certain extent is produced under pressure/protective-gas atmosphere, oxidising or reducing reaction-gas atmosphere or exposure to vacuum and simultaneous calcination at up to ⅔ to ⅚ of the melting point.

Since the conversion takes place below the melting point, the bonding of the particles to one another is facilitated by diffusion processes at the interfaces, with chemical bonds being formed in the moulding.

The present invention furthermore relates to an illumination unit having at least one primary light source whose emission maximum is in the range 240 to 510 nm, where the primary radiation is partially or fully converted into longer-wavelength radiation by the ceramic phosphor element according to the invention. This illumination unit is preferably white-emitting.

In a preferred embodiment of the illumination unit according to the invention, the light source is a luminescent indium aluminium gallium nitride, in particular of the formula InᵢGaⱼAlₖN, where 0≦i, 0≦j, 0≦k, and i+j+k=1.

In a further preferred embodiment of the illumination unit according to the invention, the light source is a luminescent compound based on ZnO, TCO (transparent conducting oxide), ZnSe or SiC or an organic light-emitting layer.

The present invention furthermore relates to the use of the ceramic phosphor element according to the invention for the conversion of blue or near-UV emission into visible white radiation.

In a preferred embodiment, the ceramic phosphor element can be employed as conversion phosphor for visible primary radiation for the generation of white light. In this case, it is particularly advantageous for high luminous power if the ceramic phosphor element absorbs a certain proportion of the visible primary radiation (in the case of invisible primary radiation, this should be absorbed in its entirety) and the remainder of the primary radiation is transmitted in the direction of the surface opposite the primary light source. It is furthermore advantageous for high luminous power if the ceramic phosphor element is as transparent as possible to the radiation emitted by it with respect to coupling-out via the surface opposite the material emitting the primary radiation. It is also preferred if the ceramic phosphor element has a ceramic density of between 80 and virtually 100%. From a ceramic density of greater than 90%, the ceramic phosphor element is distinguished by sufficiently high translucency to the secondary radiation. This means that this radiation is able to pass through the ceramic element. To this end, the ceramic phosphor element preferably has a transmission of greater than 60% for the secondary radiation of a certain wavelength.

In a further preferred embodiment, the ceramic phosphor element can be employed as conversion phosphor for UV primary radiation for the generation of white light. In this case, it is advantageous for high luminous power if the ceramic phosphor element absorbs all the primary radiation and if the ceramic phosphor element is as transparent as possible to the radiation emitted by it.

The following examples are intended to illustrate the present invention. However, they should in no way be regarded as limiting. All compounds or components which can be used in the compositions are either known and commercially available or can be synthesised by known methods. The temperatures indicated in the examples are always given in ° C. It furthermore goes without saying that, both in the description and also in the examples, the added amounts of the components in the compositions always add up to a total of 100%. Percentage data given should always be regarded in the given connection. However, they usually always relate to the weight of the part- or total amount indicated.

### EXAMPLES

### Example 1

### Preparation of Finely Pulverulent (Y_{0.98}Ce_{0.02})₃Al₅O₁₂ By Co-Precipitation With Subsequent Pressing And Sintering To Give the Phosphor Plate

29.4 ml of 0.5 M Y(NO₃)₃.6H₂O solution, 0.6 ml of 0.5 M Ce(NO₃)₃.6H₂O solution and 50 ml of 0.5 M Al(NO₃)₃.9H₂O are introduced into a dropping funnel. The combined solutions are slowly added dropwise with stirring to 80 ml of a 2 M ammonium hydrogencarbonate solution which had previously been adjusted to pH 8-9 using a little NH₃ solution. During the drop-wise addition of the acidic nitrate solution, the pH must be kept at 8-9 by addition of ammonia. After about 30-40 minutes, the entire solution should have been added, with a flocculant, white precipitate having formed.

The precipitate is allowed to age for about 1 h and is then filtered off with suction through a filter. The product is subsequently washed a number of times with deionised water.

After removal of the filter, the precipitate is transferred into a crystallisation dish and dried at 150° C. in a drying cabinet. Finally, the dried precipitate is transferred into a smaller corundum crucible, the latter is placed in a larger corundum crucible which contains a few grams of granular activated carbon, and the crucible is subsequently sealed by means of the crucible lid. The sealed crucible is placed in a chamber furnace and then calcined at 1000° C. for 4 h.

The fine phosphor powder, which consists of the precise chemical stoichiometry with respect to the requisite cations with the smallest possible amount of impurities (in particular heavy metals in each case less than 50 ppm), preferably consisting of sub-μm primary particles, is then pre-compacted in a press at 1000-10,000 bar, preferably 2000 bar, to give the corresponding plate form at a temperature of up to ⅚ of its melting point.

An additional treatment of the compact at ⅔ to ⅚ of its melting point is subsequently carried out in a chamber furnace in a forming-gas atmosphere.

### Example 2

### Preparation of A Precursor (Precursor Particles) of the Phosphor (Y_{0.98}Ce_{0.02})₃Al₅O₁₂ By Co-Precipitation

2.94 l of 0.5 M Y(NO₃)₃.6H₂O solution, 60 ml of 0.5 M Ce(NO₃)_{3.6}H₂O solution and 5 l of 0.5 M Al(NO₃)₃.9H₂O are introduced into a metering vessel. The combined solutions are slowly metered, with stirring, into 8 l of a 2 M ammonium hydrogencarbonate solution which had previously been adjusted to pH 8-9 using NH₃ solution.

During the metering of the acidic nitrate solution, the pH must be kept at 8-9 by addition of ammonia. After about 30-40 minutes, the entire solution should have been metered in, with a flocculant, white precipitate forming. The precipitate is allowed to age for about 1 h.

### Example 3

### Preparation of A Precursor of the Phosphor Y_{2.541}Gd_{0.450}Ce_{0.009}Al₅O₁₂ By Co-Precipitation

0.45 mol of Gd(NO₃)₃*6H₂O, 2.54 mol of Y(NO₃)₃*6 H₂O (M=383.012 g/mol), 5 mol of Al(NO₃)₃*9 H₂O (M=375.113) and 0.009 mol of Ce(NO₃)₃*6H₂O are dissolved in 8.2 l of dist. water. This solution is metered dropwise into 16.4 l of an aqueous solution of 26.24 mol of NH₄HCO₃ (where M=79.055 g/mol, m=2740 g) at room temperature with constant stirring. When the precipitation is complete, the precipitate is aged for one hour with stirring. The precipitate is kept in suspension by stirring. After filtration, the filter cake is washed with water and then dried at 150° C. for a few hours.

### Example 4

### Preparation of A Precursor (Precursor Particles) of the Phosphor Y_{2.88}Ce_{0.12}Al₅O₁₂ By the Pecchini Process

2.88 mol of Y(NO₃)₃*6H₂O, 5 mol of Al(NO₃)₃*9H₂O (M=375.113) and 0.12 mol of Ce(NO₃)₃*6H₂O are dissolved in 3280 ml of dist. water. This solution is added dropwise to a precipitation solution consisting of 246 g of citric acid in 820 ml of ethylene glycol at room temperature with stirring, and the dispersion is stirred until it becomes transparent. This solution is then carefully evaporated. The residue is taken up in water and filtered with washing.

### Example 5

### Preparation of A Precursor (Precursor Particles) of the Phosphor V_{2.541}Gd_{0.450}Ce_{0.009}Al₅O₁₂ By the Pecchini Process

0.45 mol of Gd(NO₃)₃*6H₂O, 2.541 mol of Y(NO₃)₃*6 H₂O (M=383.012 g/mol), 5 mol of Al(NO₃)₃*9 H₂O (M=375.113) and 0.009 mol of Ce(NO₃)₃*6H₂O are dissolved in 3280 ml of dist. water. This solution is added dropwise to a precipitation solution consisting of 246 g of citric acid in 820 ml of ethylene glycol at room temperature with stirring, and the dispersion is stirred until it becomes transparent. The dispersion is then heated to 200° C., during which the viscosity increases and finally precipitation or clouding occurs.

### Example 6

### Preparation of A Precursor (Precursor Particles) of the Phosphor Y_{2.94}Al₅O₁₂:C0_{0.06} By Means of the Combustion Method Using Urea

2.94 mol of Y(NO₃)₃*6 H₂O, 5 mol of Al(NO₃)₃*9 H₂O (M=375.113) and 0.06 mol of Ce(NO₃)₃*6H₂O are dissolved in 3280 ml of dist. water, and the solution is refluxed. 8.82 mol of urea are added to the boiling solution. On further boiling and finally partial evaporation, a fine, opaque, white foam forms. This is dried at 100° C., finely ground, re-dispersed in water and kept in suspension.

### Example 7

### Preparation of A Precursor (Precursor Particles) of the Phosphor Y_{2.541}Gd_{0.450}Ce_{0.009}Al₅O₁₂ By Means of the Combustion Method Using Urea

0.45 mol of Gd(NO₃)₃*6H₂O, 2.54 mol of Y(NO₃)₃*6 H₂O (M=383.012 g/mol), 5 mol of Al(NO₃)₃*9 H₂O (M=375.113) and 0.009 mol of Ce(NO₃)₃*6H₂O are dissolved in 3280 ml of dist. water and refluxed. 8.82 mol of urea are added to the boiling solution. On further boiling and finally partial evaporation, a fine, opaque, white foam forms. This is dried at 100° C. and finely ground and then re-dispersed in water and kept in suspension.

### Example 8

### Pressing of the Phosphor Particles To Give A Phosphor Ceramic

The fine, dried phosphor powder from Examples 2 to 7, which consists of the precise chemical stoichiometry with respect to the requisite cations with the smallest possible amount of impurities (in particular heavy metals in each case less than 50 ppm) preferably consisting of sub-pm primary particles, is then pre-compacted in a press at 1000-10,000 bar, preferably 2000 bar, to give the corresponding plate form at a temperature of up to ⅚ of its melting point. An additional treatment of the compact at ⅔ to ⅚ of its melting point is subsequently carried out in a chamber furnace in a forming-gas atmosphere.

### Example 9

### Pressing To Give A Ceramic With the Aid of Sintering Additives And Subsequent Metallisation

The precursor particles described in Examples 1 to 7 mentioned above are subjected to hot isostatic pressing using 0.1 to 1% of sintering aid (MgO, SiO₂ nanoparticles), firstly in air, then in a reducing atmosphere comprising forming gas, giving ceramics in the form of plates or a rod, which are subsequently metallised on the side surfaces with silver or aluminium and then employed as phosphor.

The metallisation is carried out as follows:

The ceramic phosphor element in the form of rods or plates resulting from the isostatic pressing is wetted on the side surfaces with a solution comprising 5% of AgNO₃ and 10% of glucose. At elevated temperature, the wetted material is exposed to an ammonia atmosphere, during which a silver coating forms on the side surfaces.

### FIGURES

The invention will be explained in greater detail below with reference to a number of working examples.

FIG. 1: shows thin ceramic plates obtained by sawing the ceramic rod having metallised surfaces 1.

FIG. 2: shows how pyramidal structures 2 can be embossed onto one surface of the thin ceramic plate by structured press platens (top). Without structured press platens (lower figure), nanoparticles of SiO₂, TiO₂, ZnO₂, ZrO₂, Al₂O₃, Y₂O₃, etc. or mixtures thereof can subsequently be applied to one side (rough side 3) of the ceramic.

FIG. 3: shows a ceramic conversion phosphor element 5 applied to the LED chip 6.

FIG. 4: SEM photomicrograph of a YAG:Ce fine powder prepared as described in Example 1.

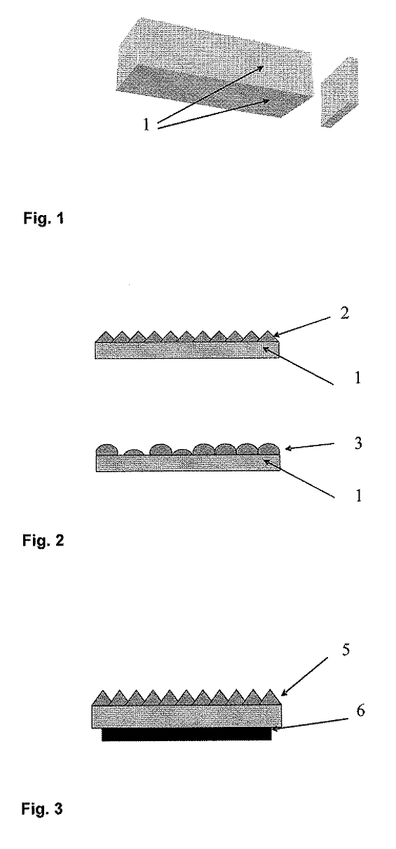

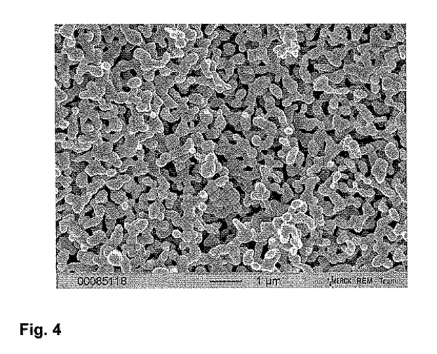

1. Ceramic phosphor element obtainable by mixing at least two starting materials with at least one dopant by wet-chemical methods and subsequent thermal treatment to give phosphor precursor particles and isostatic pressing of the phosphor precursor particles.

2. Ceramic phosphor element according to claim 1, characterised in that the phosphor precursor particles have an average diameter of 50 nm to 5 μm.

3. Ceramic phosphor element according to claim 1, characterised in that the side surfaces of the phosphor element are metallised with a light or noble metal.

4. Ceramic phosphor element according to claim 1, characterised in that the side of the phosphor element opposite an LED chip has a structured surface.

5. Ceramic phosphor element according to claim 1, characterised in that the side of the phosphor element opposite an LED chip has a rough surface which carries nanoparticles of SiO₂, TiO₂, Al₂O₃, ZnO₂, ZrO₂ and/or Y₂O₃ or mixed oxides thereof.

6. Ceramic phosphor element according to claim 1, characterised in that the side of the phosphor element facing an LED chip has a polished surface in accordance with DIN EN ISO 4287.

7. Ceramic phosphor element according to claim 1, characterised in that the starting materials and the dopant are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in inorganic and/or organic liquids.

8. Ceramic phosphor element according to claim 1, characterised in that it consists of at least one of the following phosphor materials:
(Y, Gd, Lu, Sc, Sm, Tb)₃ (Al, Ga)₅O₁₂:Ce, (Ca, Sr, Ba)₂SiO₄:Eu, YSiO₂N:Ce, Y₂Si₃O₃N₄:Ce, Gd₂Si₃O₃N₄:Ce, (Y, Gd, Tb, Lu)₃Al₅₋ₓSiₓO₁₂₋ₓNₓ:Ce, BaMgAl₁₀O₁₇:Eu, SrAl₂O₄:Eu, Sr₄Al₁₄O₂₅:Eu, (Ca, Sr, Ba)Si₂N₂O₂:Eu, SrSiAl₂O₃N₂:Eu, (Ca, Sr, Ba)₂Si₅N₈:Eu, CaAlSiN₃:Eu, molybdates, tungstates, vanadates, group III nitrides, oxides, in each case individually or mixtures thereof with one or more activator ions, such as Ce, Eu, Mn, Cr and/or Bi.

9. Process for the production of a ceramic phosphor element having the following process steps:
a) preparation of a phosphor by mixing at least two starting materials and at least one dopant by wet-chemical methods
b) thermal treatment of the resultant phosphor precursor particles
c) isostatic pressing of the phosphor precursor particles to give a ceramic phosphor element.

10. Process according to claim 9, characterised in that the wet-chemical preparation of the phosphor precursors in process step a) is selected from one of the following 5 methods:
co-precipitation using an NH₄HCO₃ solution
Pecchini process using a solution of citric acid and ethylene glycol
combustion process using urea
spray drying of the dispersed starting materials
spray pyrolysis of the dispersed starting materials.

11. Process according to claim 9, characterised in that, before the isostatic pressing, a sintering aid, such as SiO₂ or MgO nanopowder, is added to the phosphor precursor.

12. Process according to claim 9, characterised in that the isostatic pressing is a hot isostatic pressing.

13. Process according to claim 9, characterised in that the side surfaces of the ceramic phosphor element are metallised with a light or noble metal.

14. Process according to claim 9, characterised in that the surface of the ceramic phosphor element facing away from the LED chip is coated with nanoparticles of SiO₂, TiO₂, Al₂O₃, ZnO₂, ZrO₂ and/or Y₂O₃ or mixed oxides thereof.

15. Process according to claim 9, characterised in that a structured surface is produced on the side of the ceramic phosphor element facing away from the LED chip using a structured compression mould.

16. Illumination unit having at least one primary light source whose emission maximum is in the range 240 to 510 nm, where this radiation is partially or fully converted into longer-wavelength radiation by a ceramic phosphor element according to claim 1.

17. Illumination unit according to claim 16, characterised in that the light source is a luminescent indium aluminium gallium nitride, in particular of the formula InᵢGaⱼAlₖN, where 0≦i, 0≦j, 0≦k, and i+j+k=1.

18. Illumination unit according to claim 16, characterised in that the light source is a luminescent compound based on ZnO, TCO (transparent conducting oxide), ZnSe or SiC.

19. Illumination unit according to claim 16, characterised in that the light source is an organic light-emitting layer.

20. Use of the ceramic phosphor element according to claim 1 for the conversion of blue or near-UV emission into visible white radiation.
